(19) United States
(12) Patent Application Publication
(10) Pub. No.: US 2005/0127554 A1
(43) Pub. Date: Jun. 16, 2005

(54) Method and apparatus for cutting a poly (vinyl alcohol) member

(75) Inventor: Maurice William Smith, Barton (GB)

Correspondence Address: NORRIS, MCLAUGHLIN & MARCUS, 875 THIRD AVE, 18TH FLOOR, NEW YORK, NY, 10022, US

(73) Assignee: Reckitt Benckiser (UK) Limited, Berkshire (GB)

(21) Appl. No.: 10/495,712

(22) PCT Filed: Oct. 17, 2002
(86) PCT No.: PCT/GB02/04700

(30) Foreign Application Priority Data
Nov. 21, 2001 (GB) 0127808.4

(51) Int. Cl. B26D 1/00; B29C 37/00

(52) U.S. Cl. 264/138; 264/160; 425/297; 425/110

(57) ABSTRACT

A process for cutting a poly (vinyl alcohol) (PVOH) member, which comprises cutting the member with a cutting edge, the cutting edge having a temperature of at least 100° C.

The present invention relates to a process for cutting a poly (vinyl alcohol) (PVOH) member, especially in the form of a film or sheet, and to a cutting machine for cutting through films or sheets of PVOH.

Synthetic polymeric materials, despite increased costs of raw materials required for their synthesis, continue to be widely used in the manufacturing industry. The polymeric material can be used either to form the goods being manufactured or for their packaging.

Where the goods or packaging are required to dissolve in water, either once the article has carried out its function or to release the contents of the packaging, then it is advantageous if the material used is, in addition to being soluble, biodegradable. The principal reason for using polymeric material for both of these uses is that, generally speaking, the properties of a polymer can be tailored to suit the particular requirements. For example, by using appropriate starting materials and production conditions, the tensile strength, elasticity, density, biodegradability, solubility, hydrophobicity etc. can be altered according to the proposed application or final end use.

Typically the material of choice in such situations is a PVOH which has good solubility characteristics. PVOH is also biodegradable which makes it particularly suited for passing into the waste-water treatment system.

Exemplary of a type of packaging is a matrix array of cavities formed in a sheet of PVOH, the cavities holding solid or liquid product. The cavities are of an appropriate size to receive and retain the product. When the product has been added to the cavity, a sealing sheet is overlaid and sealed to the lower sheet. Individual pouches are then produced by cutting the sheet.

The difficulty with using PVOH as a polymeric sheet material is that PVOH is a relatively elastic and deformable polymer at ambient temperatures, which makes it difficult to cut. In known processes for cutting PVOH, a knife or blade at room temperature has been used. In order to accomplish the cutting a very sharp blade is required which must be applied with a considerable degree of force. The blade used needs to be sharpened frequently, which slows down production. A further possible solution to the problem of removing individual pouches, namely simply perforating the sheets to provide a line along which the consumer can tear out individual pouches to obtain a single pouch, does not work. The PVOH's tensile properties make the sheet difficult to tear along the perforations.

Since PVOH is known to become soft when subjected to heat, it has been thought that room temperature is the appropriate temperature for the blade when it is used to cut PVOH. Furthermore, it is known that excess heat when applied to PVOH will reduce its solubility. This is a major disadvantage when it is desired to retain the water-soluble characteristics of PVOH. We have now surprisingly found that a knife or blade having a higher temperature can be used to cut PVOH without contaminating the blade with molten or burnt PVOH and without affecting the water-solubility of the PVOH. We have also surprisingly found that such a heated knife or blade may cut the PVOH better than an unheated knife or blade and, furthermore, that the heated knife or blade may require sharpening less often than an unheated knife or blade.

The present invention provides a process for cutting a PVOH member, such as a sheet or film, which comprises cutting the member with a cutting edge, the cutting edge having a temperature of at least 100° C.

The present invention also provides a process for cutting a PVOH member, such as a sheet or film of PVOH, the process comprising the steps of:
i) heating a cutting edge to a temperature greater than 100° C., the cutting edge defined by a pair of angled sides;
ii) drawing material, i.e. the member, to be cut into proximity of the cutting edge;
iii) engaging the member, for example in the form of a film or sheet, with the cutting edge using sufficient applied force to cut the member; and
iv) moving the material and the cutting edge relative to each other in order to effect a cut,
   the two sides defining the cutting edge subtending an angle of less than 30° with respect to one another.

The present invention additionally provides an apparatus for cutting sheets, the apparatus including:
i) a product loading station in which product is loaded into a pre-formed compartment of a first polymeric material;
ii) a sealing station in which a sheet of a second polymeric material is overlaid over the first polymeric material and sealed thereto to form a laminate, either one or both of the first and second polymeric materials being a PVOH;
iii) a cutting station having a heated cutting edge defined by a pair of angled sides to engage and cut the laminated material; and
iv) a packaging station to package the cut product,
   the cutting edge being heated to a temperature of greater than 100° C. and the two sides defining the cutting edge subtending at an angle of less than 30° with respect to one another.

The temperature of the cutting edge is greater than 100° C., preferably from 110° C. to 160° C., and most preferably from 130° C. to 140° C. The precise temperature is not absolutely critical; the heated cutting edge may simply be kept at a temperature within a pre-set temperature range, for example within 5° C. or 10° C. of the desired temperature.

It is usual for a cutting edge to be defined by two sides subtending at a suitable angle from each other. Any angle can be used in the present invention, although it is desirable for the angle to be less than 30°, preferably from 12 to 18°. A sharper edge allows thicker members such a sheets to be cut more easily.

The cutting edge may, for example, be disposed on a rotating knife, a non-rotating knife, a rotary crusher or on a rule or a die, for example a steel rule or die. The choice of cutting edge, for example knife, will depend on the particular configuration into which the material is to be cut.

The cutting edge may cut against a base, such as an anvil or a roller (as described below), that supports the member during the cutting operation (a crush cutting operation). The base may be made of any suitable resilient material such as metal or a rubberised surface. The cutting edge may operate against an opposing stationary or moving edge, which may or may not be a cutting edge in accordance with this invention (a shear cutting operation).

In a feature of the invention the cutting edge is disposed on a die. The die may be any 2-dimensional shape, such as a square, rectangle, circle or oval, thereby having the advantage that more complex shapes can be cut out of the member, such as curves and acute (less than 90°) angles. An additional advantage is that it avoids the need for a separate cutting edge to cut in each of the x and y axis of the member. A further feature is that the die may be connected to a vacuum source thereby allowing the die to lift the cut piece from the member after the cutting operation. In a further advantage the die may rotate about its vertical axis further improving the cutting efficiency of the die.

Advantageously the cutting edge is disposed along and substantially perpendicular to the circumference of a roller. Disposing the cutting edge along the roller allows the cutting edge to rotate with the motion of the material so that the portion of the cutting edge engaging the material is maintained at a higher temperature. Conveniently the roller is in the form of a disc to enable an array of rollers to be used to cut a member such as a film or sheet into more than one section. The use of a number of discs enables individual discs to be replaced when required rather than an entire roller.

Advantageously the cutting edge is curved. The curve preferably has a cross-section having a radius of curvature of from 0.3 to 0.7 mm, with about 0.5 mm being particularly preferred. The curvature of the cutting edge prolongs the useful lifetime of the cutting edge.

Any PVOH can be cut using the process of the present invention, although it is preferred that the PVOH is water-soluble. An example of a preferred PVOH which can constitute the PVOH member is ethoxylated PVOH. The PVOH may be partially or fully alcoholised or hydrolysed. For example it may be at least 40% , preferably from 70 to 92% , more preferably about 88% or about 92% , alcoholised or hydrolysed. The degree of hydrolysis is known to influence the temperature at which the PVOH starts to dissolve in water. 88% hydrolysis corresponds to a PVOH soluble in cold (i.e. room temperature) water, whereas 92% hydrolysis corresponds to a PVOH soluble in warm water. A preferred PVOH which can be further processed, for example by forming into a film or by moulding such as injection moulding, is sold in the form of granules under the name CP1210T05 by Soltec Developpement SA of Paris, France.

Advantageously the PVOH may be substantially anhydrous, that is contain less than 5 wt % water, preferably less than 2 wt % water. We have found that such PVOH, particularly if it is in the form of a film, is less liable to shrink on heating, for example during a thermoforming step.

The PVOH member may have any form. Desirably, however, it is in the form of a sheet or film. In general the sheet or film has a thickness of from 40 to 300 μm, preferably from 80 to 200 μm, more preferably from 100 to 150 μm, and most preferably from 120 to 150 μm.

The PVOH member is not necessarily in the form of a sheet or film; it may have any thickness, shape or form. The PVOH member may, for example, be rigid or flexible. The PVOH member may, for example, be in the form of a three-dimensional moulding. It may, for example, have a thickness in the area of cutting of from 15 μm to 30 mm, preferably 30 μm to 25 mm, more preferably 80 μm to 20 mm. Preferably, however, the member is in the form of a film or sheet

The PVOH member is desirably in a form such that, when the film is sealed to it, there is provided a water-soluble container containing at least one composition. Thus the PVOH member can, for example, be in the form of a film or sheet having a pocket therein. The pocket can be produced by a moulding technique, for example thermoforming, vacuum moulding, injection moulding or blow moulding.

If the member is integral with the film before they are sealed together, and in the form of a single film which is heat sealed to itself, a horizontal or vertical form fill sealing process can be carried out to provide envelopes containing a composition. Pillow packs can also be produced from two different films.

In another embodiment, the PVOH member can be in the form of a more rigid moulding, for example produced by injection moulding or blow moulding. Such a moulding can be in the form of an open container which is filled with at least one composition and then sealed with at least one film by the process of the present invention. Such containers are disclosed, for example, in WO 01/36,290.

An injection moulded member forming a container has walls which generally have a thickness such that the container is rigid. For example, the outside walls and any inside walls may independently have a thickness of greater than 100 μm, for example greater than 150 μm or greater than 200 μm, 300 μm, 400 μm, 500 μm, 750 μm or 1 mm. Typically the thicknesses are from 200 μm to 1,000 μm, preferably 300 μm to 500 μm.

The container can also be made from two films, one of the films constituting the water-soluble member. For example a suitable process comprises:
a. producing a pocket surrounded by a sealing portion in a film;
b. filling the pocket with the composition;
c. placing a film on top of the filled pocket and across the sealing portion; and
d. sealing the films together at the sealing portion, for example by heat sealing.

The thickness of the film used to produce the pocket is preferably 40 to 300 μm, more preferably 80 to 200 μm, especially 100 to 160 μm, more especially 100 to 150 μm and most especially 120 to 150 μm.

The pocket may be formed by, for example, vacuum forming or thermoforming. For example, in a thermoforming process the film may be drawn down or blown down into a mould. Thus, for example, the film is heated to the thermoforming temperature using a thermoforming heater plate assembly, and then drawn down under vacuum or blown down under pressure into the mould. One skilled in the art can choose an appropriate temperature, pressure or vacuum and dwell time to achieve an appropriate pocket. The amount of vacuum or pressure and the thermoforming temperature used depend on the thickness and porosity of the film and on the polymer or mixture of polymers being used. Thermoforming of films is a well-known technique; thermoforming of PVOH films is described in, for example, WO 00/55045.

After the pocket has been filled with the desired composition, a film is placed on top of the filled pocket and across the sealing portion, and the film are heat sealed together at the sealing portion by the process of the present invention. The thickness of the covering film is generally from 20 to 160 μm, preferably from 40 to 100 μm, such as 40 to 80 μm or 75 to 95 μm.

In all of the above embodiments, the individual containers, or groups of containers, can be separated using the cutting process of the present invention.

The PVOH member, especially when it is in the form of a sheet or film, may be a single member or a laminated member, for example the sheet or film as disclosed in GB-A-2,244,258. While a single film may have pinholes, the two or more layers in a laminate are unlikely to have pinholes which coincide

The member, for example a sheet or film, may be produced by any process, for example by moulding such as injection moulding or by extrusion and blowing or by casting. The sheet or film may be unoriented, monoaxially oriented or biaxially oriented. If the layers in the sheet or film are oriented, they usually have the same orientation, although their planes of orientation may be different if desired.

The layers in a laminate may be the same or different. Thus they may each comprise the same PVOH polymer or different PVOH polymers, or even a PVOH polymer and another polymer. Since the film is laminate is intended to be water-soluble, each of the layers should be water-soluble.

The composition(s) which can be held in the container, or in each compartment of the container may independently be a fabric care, surface care or dishwashing composition. Thus, for example, they may be a dishwashing, water-softening, laundry or detergent composition, or a rinse aid. Such compositions may be suitable for use in a domestic washing machine. The compositions may also independently be a disinfectant, antibacterial or antiseptic composition, or a refill composition for a trigger-type spray. Such compositions are generally packaged in total amounts of from 5 to 100 g, especially from 15 to 40 g. For example, a laundry composition may weigh from 15 to 40 g, a dishwashing composition may weigh from 15 to 30 g and a water-softening composition may weigh from 15 to 40 g.

The composition(s) may be a solid. For example, it may be a particulate or granulated solid, or a tablet. It may also be a liquid, which may be thickened or gelled if desired. The liquid composition may be non-aqueous (i.e. anhydrous) or aqueous, for example comprising less than or more than 5 wt % total or free water. An anhydrous composition generally contains less than 1 wt %, preferably less than 0.5 wt % water. The composition may have more than one phase. For example it may comprise an aqueous composition and a liquid composition which is immiscible with the aqueous composition. It may also comprise a liquid composition and a separate solid composition, for example in the form of a ball, or pill or speckles. The liquid composition may be thickened or gelled.

If the composition is an aqueous liquid having a relatively high water content, for example above 5 wt % water, it may be necessary to take steps to ensure that the liquid does not attack the water-soluble PVOH if it is soluble in cold water, or water up to a temperature of, say, 350° C. Steps may be taken to treat the inside surfaces of the container, for example by coating it with agents such as PVdC (poly(vinylidene dichloride)) or PTFE (polytetrafluoroethylene), or to adapt the composition to ensure it does not dissolve the PVOH. For example, it has been found that ensuring the composition has a high ionic strength or contains an agent which minimises water loss through the walls of the container will prevent the composition form dissolving the PVOH from the inside. This is described in more detail in EP-A-518,689 and WO 97/27,743.

The containers may have any desired shape. For example the container can have a irregular or regular geometrical shape such as a cube, cuboid, pyramid, dodecahedron or cylinder. The cylinder may have any desired cross-section, such as a circular, triangular or square cross-section.

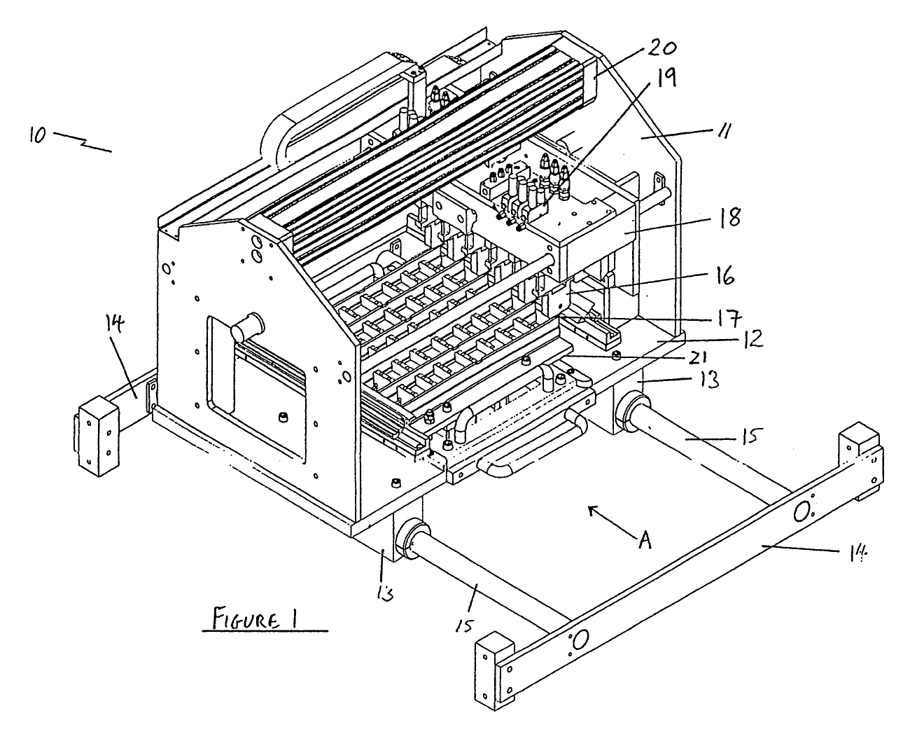

Referring now to the drawings, and initially to FIG. 1, a cutter 10 is retained within a frame assembly 11 which includes a base plate 12. Fixed to the underside of the base plate 12 are a pair of slider receivers 13 for sliding and retaining the cutter 10 in relationship with the assembly line. In FIG. 1 the assembly line is illustrated with reference only to machine mounting bars 14 between which are secured a pair of sliders 15 engaged by the slider receivers 13.

A series of knife holders 16 and heated blades 17 are mounted onto a knife support unit 18. The knife holders are so mounted as to enable them to be moved both laterally and vertically. The vertical motion of the knife holder 16 is governed by a pneumatic flow module 19 and is principally between a sheet cutting position and a rest position. The lateral motion of the knife holders 16 is controlled by a knife traverse pneumatic cylinder 20. The temperature of the blades 17 can be controlled by the person operating the apparatus, the exact temperature set depending upon the material to be cut. Heating for the blades 17 is provided by electrical cartridge heaters. Once the temperature required has been determined, this will be programmed into the machine by the operator and subsequently automatically controlled to within a pre-set limit about this temperature by the machine.

The knife holders 16 are provided in a linear array along the direction of motion A of the sheet of material. The number of knife holders 16 and hence the number of blades 17 will be determined by the size of the machine, the size of the compartments and the number of cuts to be made in any one pass of the blade 17 across the sheet.

An anvil 21 is provided in order to provide a surface against which the blades 17 press when cutting a material. The anvil 21 extends across an area of the base plate 12, the area being of sufficient size as to provide a surface for each blade 17. The anvil 21 itself can be adjusted up and down along a vertical line in order that the anvil can push the sheet of material towards the blade 17 to facilitate the achievement of a clean cut.

Where required, due to the nature of the product being packaged, the entire cutter assembly 10 can be enclosed within an airtight hood (not illustrated), in order to prevent contamination or degradation of the sheet material or the product prior to its packaging.

In use, pockets are formed into a first sheet of packaging material formed of PVOH. The product to be packaged is put into the pockets thus formed. The first sheet together with the product pass to a sealing station in which a second sheet, also formed of PVOH, is overlaid onto the first sheet. The second sheet is sealed to the first sheet by means of adhesive pressure being used to form the seal. The seals are located such that the product in one packet is isolated from the product in another pocket.

From the sealing station, the packaged product is passed into the cutter assembly, in the direction indicated by A in FIG. 1. The seals of the packaged product are positioned above the anvils 21. The anvils 21 are raised until they contact the seals. The heated blades are lowered and traverse the length of the seals, in unison, to cut the seals and so produce the individually packaged product. The packaged product is then conveyed to a packing station and packed into a suitable form for supply to the customer.

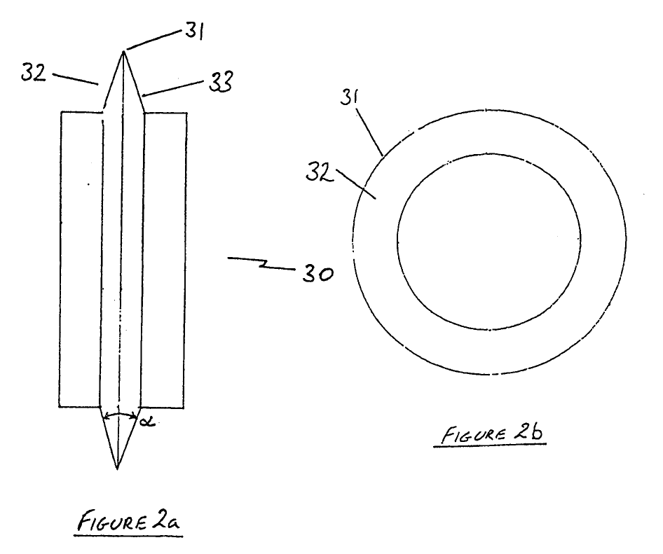

FIGS. 2a and 2b show a cutting element in the form of a disc blade 30 having a cutting edge 31. The two surfaces 32, 33 of the cutting edge 31 define an angle α.

The exemplified angle α is 15°. Normally the disc blade 30 is mounted such that it is freely rotatable about its main axis and can rotate during the cutting action.

Further examples of cutting elements (not illustrated) incorporating a heated cutting edge are as follows:

Firstly, a non-rotating blade can be used. Cutting is then performed either by maintaining the blade in a static position and moving the polymer sheet, or the sheet remains static and the blade can be drawn across its surface.

Secondly, the steel-rule type blade can be used. Such a blade will typically be used in a non-continuous fashion by being lifted from the sheet, lowered to cut the sheet and then re-lifted from the sheet. Repositioning of the sheet with respect to the blade then takes place in order to bring the blade aver the next portion of the sheet to be cut.

Thirdly, a rotary crusher can be used. A rotary crusher operates as follows: The blade is mounted to a first roller, the roller being urged to forcibly engage a second roller. The sheet to be cut is passed between the two rollers which rotate in synchronous fashion. As the sheet passes between the two rollers, the blades on the first roller cut the sheet, the second roller functioning as a base against which the blades can push.

Heating to the blades is normally supplied by means of electrical cartridge heaters. The temperature of the blade is normally greater than 100° C. and more especially from 110° C. to 160° C.

The process as described can be used to cut either continuous or intermittent web material. In addition to heated blades being provided to produce a lateral cut across the sheet of material a further heated blade or series of heated blades can also be included to cut the sheet of material in the direction of motion through the machine of the sheet of material.

The web itself can be a single layer or comprise a laminate structure. The process and apparatus are particularly suitable to cut sheets having a thickness of 60 to 300 μm, although other thicknesses can be accommodated with a suitable blade.

The angle of the blade (a in FIG. 2) required would depend substantially on the thickness of the material being cut. In general a thicker material will require a smaller value for α, i.e. a sharper blade. Typically the angle a has a value of less than 30°, although a value of from 12° to 18° has been found to be advantageous.

The cutting edge can have a curved cross-section. Curves having a radius of curvature of 0.3 to 0.7 mm have been found to be advantageous, with a value of approximately 0.5 mm being particularly advantageous. The curvature prolongs the length of time a blade can be used before it needs to be replaced which results in obvious cost savings to the user and increased production.

It will of course be understood that the invention is not limited to the specific details described herein, which are given by way of example only, and that various modifications and alterations are possible within the scope of the invention.

1. A process for cutting a poly (vinyl alcohol) (PVOH) member, which comprises cutting the member with a cutting edge, the cutting edge having a temperature of greater than 100° C.

2. A process according to claim 1 wherein the PVOH member is in the form of a sheet or film.

3. A process according to claim 1 wherein the sheet or film has a thickness of from 40 to 300 μm.

4. A process according to claim 1 wherein the cutting edge is defined by a pair of angled sides subtending at an angle of less than 30° with respect to one another.

5. A process according to claim 1 the process comprising the steps of:
i) heating the cutting edge to a temperature of from 110 to 160° C., the cutting edge defined by a pair of angled sides;
ii) drawing material to be cut into proximity of the cutting edge;
iii) engaging the sheet or film with the cutting edge using sufficient applied force to cut the sheet or film; and
iv) moving the material and the cutting edge relative to each other in order to effect a cut,
the two sides defining the cutting edge subtending an angle of less than 30° with respect to one another.

6. A process according to claim 3 wherein the angle between the two sides defining the cutting edge is from 12 to 18°.

7. A process according to claim 1 wherein the cutting edge is disposed along and substantially perpendicular to the circumference of a roller.

8. A process according to claim 1 wherein the cutting edge is disposed on a rotating knife, a non-rotating knife, a rotary crusher or on a steel rule or die.

9. A process according to claim 1 wherein the cutting edge is curved.

10. A process according to claim 1 wherein the PVOH is water-soluble.

11. A process according to claim 9 wherein the temperature of the cutting edge is insufficient to affect the solubility characteristics of the PVOH.

12. An apparatus for cutting sheets, the apparatus including:
i) a product loading station in which product is loaded into a pre-formed compartment of a first polymeric material;
ii) a sealing station in which a sheet of a second polymeric material is overlaid over the first polymeric material and sealed thereto to form a laminate, either one or both of the first and second polymeric materials being a PVOH;
iii) a cutting station having a heated cutting edge defined by a pair of angled sides to engage and cut the laminated material; and
iv) a packaging station to package the cut product, the cutting edge being heated to a temperature of greater than 100° C. and the two sides defining the cutting edge subtending at an angle of less than 30° with respect to one another.

13. A process for cutting a poly (vinyl alcohol) (PVOH) member according to claim 1, which comprises cutting the member with a cutting edge, the cutting edge having a temperature of from 110 to 160° C.

14. A process for cutting a poly (vinyl alcohol) (PVOH) member according to claim 1, which comprises cutting the member with a cutting edge, the cutting edge having a temperature of from 130 to 140° C. 15. An apparatus for cutting sheets according to claim 12 wherein the cutting edge is heated to a temperature of from 110° C. to 160° C. 16. An apparatus for cutting sheets according to claim 12 wherein the cutting edge is heated to a temperature of from 130° C. to 140° C.
